(19) United States
(12) Patent Application Publication
(10) Pub. No.: US 2012/0205918 A1
(43) Pub. Date: Aug. 16, 2012

(54) Power Generator

(76) Inventor: Antonio Ancona, Crofton, MD (US)

(21) Appl. No.: 13/455,203

(22) Filed: Apr. 25, 2012

Related U.S. Application Data
(63) Continuation-in-part of application No. 12/462,765, filed on Aug. 10, 2009.

(51) Int. Cl. H02K 7/18; F01K 25/00; F01K 3/00; F02C 1/05

(52) U.S. Cl. 290/1 R; 60/659; 60/671

(57) ABSTRACT

A closed loop thermodynamic system acts as power generator. The system includes an air blower, an expansion coil, a compressor, a large heat storage tank, a gas turbine, and an electric generator. The expansion coil includes heat absorption tubes which extract heat from air circulated by the blower and add heat to a refrigerant within the exchanger tubes. The compressor condenses the refrigerant into a large heat storage tank. The compressed liquid is allowed to expand into a high pressure gas which drives the gas turbine to drive an electric generator. The generator electricity is converted into household electricity which is used to provide electric power.

This application is a continuation-in-part of U.S. application Ser. No. 12/462,765 filed Aug. 10, 2009.

### BACKGROUND OF THE INVENTION

According to the first law of physics, energy is neither created nor destroyed. It is only transformed from one state to another. In addition, the first law of thermodynamics provides that the increase in the eternal energy of a system is equal to the amount of energy added to the system less the amount lost due to the work performed by the system on its surroundings. The second law of thermodynamics provides that energy can be transferred only from a high heat system to a low heat system.

Using the above principles, heat pumps have been developed in order to extract heat from the atmosphere or a building in order to heat or cool the building. Current heat pumps have a coefficient of performance (COP) factor of between 3 and 5. The present invention was developed in order to provide a power generator which satisfies the laws of physics and thermodynamics with a similar coefficient of performance to produce a net energy gain of 1 to 2 times the input energy with a total output of 2 to 3 times the input energy.

### SUMMARY OF THE INVENTION

Accordingly, it is a primary object of the invention to provide a power generating system including a first expansion coil containing a gaseous refrigerant for withdrawing heat from a fluid passing through the expansion coil. A compressor is connected with the first expansion coil and compresses the refrigerant from the first expansion coil and converts it to a liquid state at high temperature and pressure. A heat storage tank connected with the compressor stores heat from the liquefied refrigerant and converts the liquefied refrigerant to a hot gaseous state. A motor is connected with the heat storage tank and is driven by hot gas from the tank to produce a mechanical output while cooling the gas for delivery to the first expansion coil. A generator is connected with the motor and generates electricity from the mechanical output from the motor. The motor is preferably a gas turbine.

The heat storage tank includes a condenser having an expansion coil which allows the liquefied refrigerant to expand into a hot high pressure gas within the heat storage tank. In addition, a bypass circuit is connected with an inlet to the expansion coil and an outlet of the motor for recirculating cooled gas to the heat storage tank and provide for continuous heat absorption by the expansion coil.

The first expansion coil includes a plurality of spaced parallel tubes through which the gaseous refrigerant flows, the tubes absorbing heat from the fluid passing through the first expansion coil.

In an alternate embodiment of the invention, a second expansion coil is connected with the bypass circuit and a second compressor is connected with the second expansion coil for delivering additional hot liquefied refrigerant to the heat storage tank.

### BRIEF DESCRIPTION OF THE FIGURES

Other objects and advantages of the invention will become apparent from a study of the following specification when viewed in the light of the accompanying drawing, in which:

FIG. 1 is a schematic diagram of the power generator according to a preferred embodiment of the invention;

FIG. 2a is a detailed view of the expansion coil of the power generator of FIG. 1;

FIG. 2b is a detailed view of the finned tubes for the expansion coil of FIG. 2a according to a preferred embodiment of the invention;

FIG. 2c is a sectional view of the expansion tubes taken along line 2c-2c of FIG. 2b; and FIGS. 3 and 4 are schematic views of alternate embodiments, respectively, of the power generator according to the invention.

### DETAILED DESCRIPTION

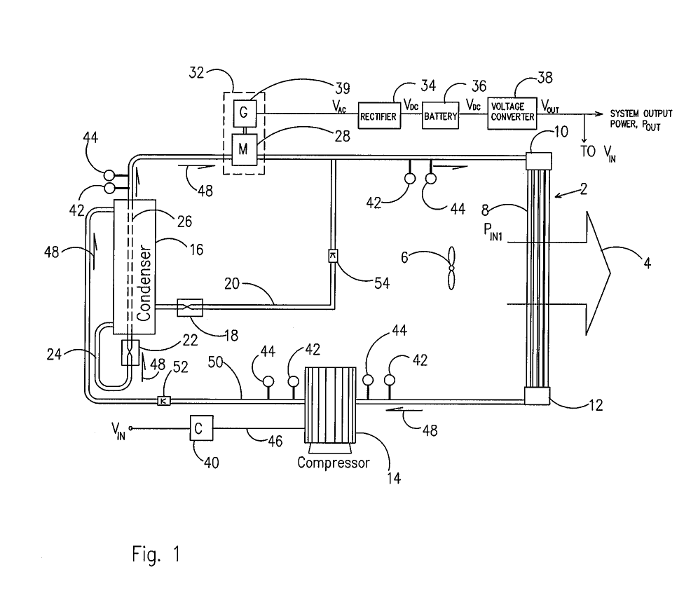

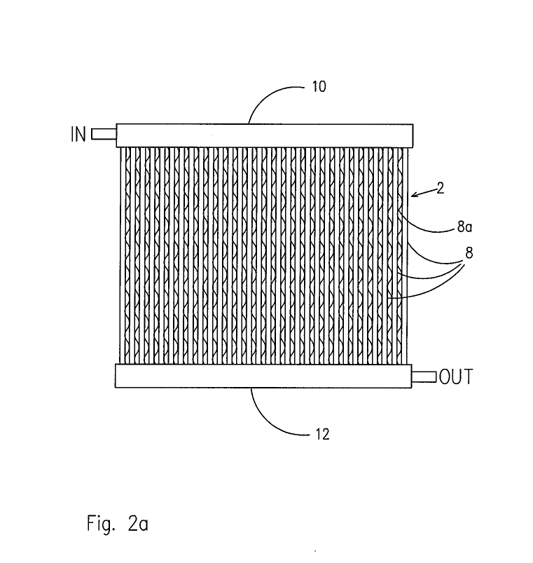

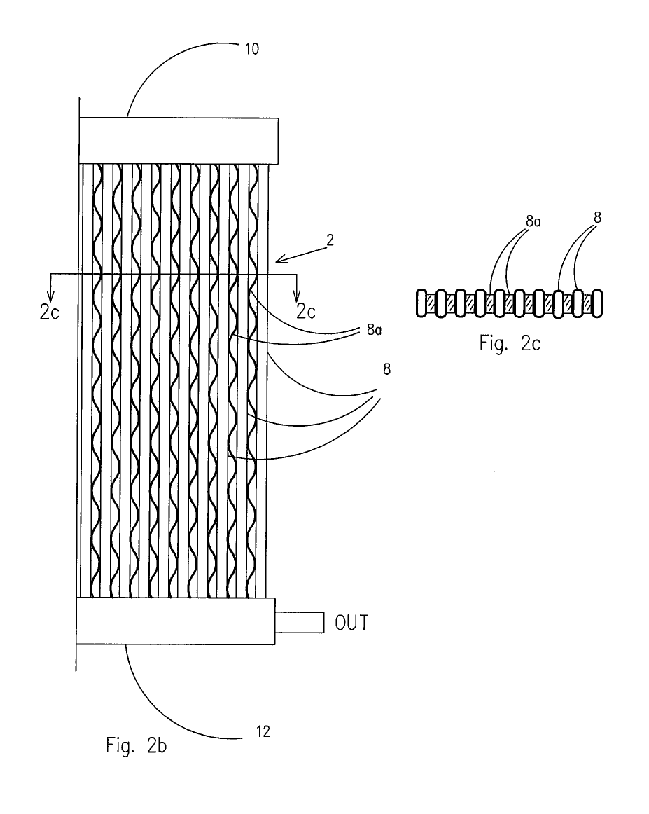

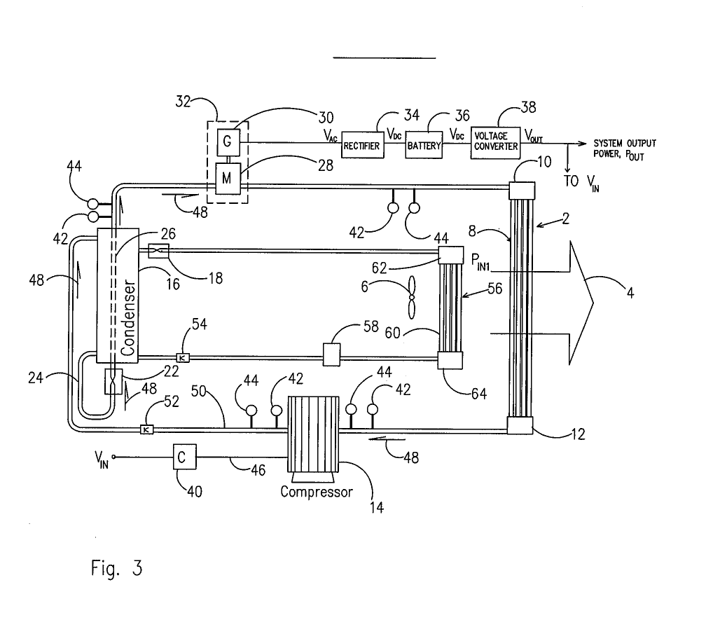

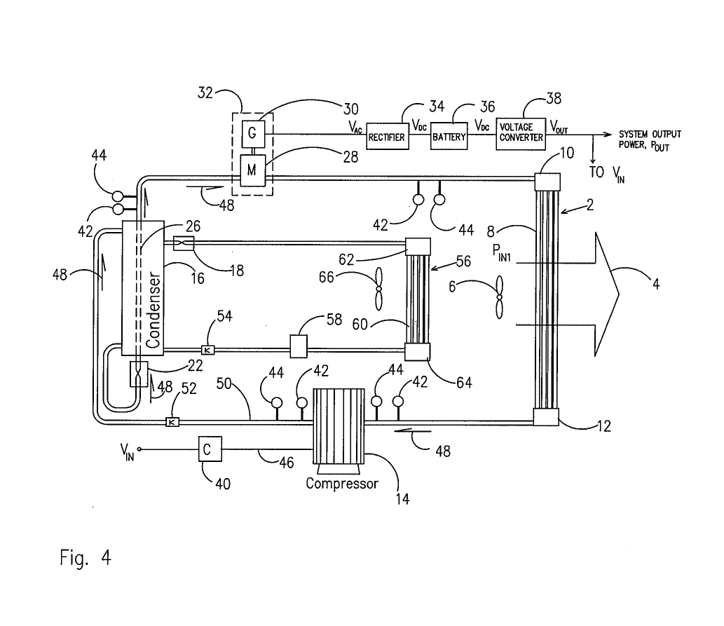

The present invention is a power generator in the form of a thermodynamic closed loop system which uses a heat pump principle to convert heat from air, water or other fluid source into mechanical and electrical energy or to drive a machine. A preferred embodiment of the invention will be described with reference to FIG. 1. As shown therein, the system includes an expansion coil 2 through which a fluid 4 such as air or water is circulated by a blower 6. The expansion coil, which is analogous to the radiator of a motor vehicle, includes a plurality of parallel spaced tubes 8 through which a refrigerant is circulated. The tubes are shown in greater detail in FIGS. 2a-c. The absorption tubes are low pressure drop tubes which limit the pressure differential across the expansion coil as will be developed in greater detail below. In the preferred embodiment, the absorption tubes 8 each include at least one fin 8a to absorb a greater amount of heat.

The input to the expansion coil includes a gas distribution manifold 10 to disperse the refrigerant. The temperature of the refrigerant, which is preferably in a gaseous state, is less than the temperature of the fluid flow. Thus, the tubes absorb heat from the fluid and raise the temperature of the refrigerant.

From the expansion coil, the refrigerant flows to a gas collector tank 12 for delivery to a compressor 14 where the gaseous refrigerant is compressed. The compression process raises the temperature and pressure of the refrigerant to such an extent that it is converted to a liquid state for delivery to a heat storage tank 16. The tank is insulated to minimize heat loss. Within the heat storage tank is a condenser which converts the refrigerant back to a gaseous state as will be developed below.

A first expansion valve 18 is provided in a bypass line 20 connected with the heat storage tank. A second expansion valve 22 is connected in a recirculation line 24 connected with a first outlet of the tank. The second expansion valve 22 is a high temperature, high pressure, high volume expansion valve. Both expansion valves 18 and 22 are electronically controlled as will be developed below.

The expansion valve 22 allows the liquefied refrigerant to expand into a hot high pressure gas, while the expansion valve 18 maintains a cool gas flow through the expansion coil of the condenser to provide for continuous heat absorption by the expansion coil and maintain the heat storage tank at full capacity when the system is not generating electricity.

Additional heat is added to the hot liquefied refrigerant by re-circulating it through the heat storage tank via a re-heat pipe 26. Additional re-heat pipes may be provided if desired. The addition of heat to the liquefied refrigerant removes un-liquefied refrigerant from the flow.

The pressure differential of the refrigerant gas at the discharge side of the high temperature pressure expansion valve 22 and the low cold refrigerant gas in the absorption tubes of the expansion coil drives a motor 28 at the output of the heat storage tank. The motor is preferably a gas turbine which drives a generator 30. The motor and generator can be packaged together in an assembly 32. In the process of turning the motor, the hot refrigerant gas converts most of its energy into mechanical energy and cools down. By limiting the pressure differential across the coil through use of absorption tubes, the pressure differential across the motor is maximized to increase the energy output. The refrigerant gas cools further on re-entry into the heat absorption tubes of the expansion coil as it expands. The refrigerant gas is thus able to absorb more heat from the fluid circulated past the absorption tubes. The refrigerant gas in the tubes of the expansion coil absorbs heat and repeats the cycle.

The generator 30 produces a variable frequency alternating current V_{AC}. A rectifier 34 is connected with the generator and converts the alternating current into a direct current _{VDC} for charging a storage battery 36. A combination rectifier/inverter may be provided to limit the battery function. The storage battery feeds a voltage converter 38, which may comprise the inverter, to generate fixed frequency alternating current which is the system output. The current can be generated with different frequencies or voltages to conform to other voltage and frequency requirements. The inverter output voltage V_{OUT} provides electric power to homes, residential buildings and the like and can be used to power any device.

A controller 40 is used to control the operation of the various components of the system including the compressor, the condenser, the blower, and the expansion valves. The temperature and pressure is measured at various locations within the system via temperature sensors 42 and pressure sensors 44. These measurements are delivered to the controller, such as via a wireless communication system or via a wired control circuit 46, to control the operation of the system.

As described above, refrigerant flows from the expansion coil to the compressor, the condenser, the motor and back to the expansion coil. The direction of flow is represented by arrows 48. A pipe 50 between the compressor and the condenser includes a check valve 52 to prevent backflow of the refrigerant into the compressor. Similarly, a check valve 54 in the bypass line 20 prevents refrigerant from flowing back to the condenser.

The power generating system according to the invention has the potential of producing three times the electric energy that is used to run the compressor and the blower. If the condenser, the turbine and all other hot pipes are properly insulated, it is possible that over 90% of the heat energy pumped to the condenser can be recovered and converted into mechanical energy and subsequently into electrical energy for a net energy gain of one to two times the input energy and a total output of two to three times the input energy. Most of the energy used to run the compressor is converted into heat and effectively reduces the amount of fluid (air or water) needed to run the system.

An alternate embodiment of the invention is shown in FIG. 3. In this embodiment, a second expansion coil 56 is connected in the bypass line which feeds back to the condenser 16 via a second compressor 58. The second expansion coil comprises a plurality of low pressure absorption tubes 60, a gas distribution manifold 62, and a gas collector tank 64. The blower 6 circulates a fluid through the first and second expansion coils. The secondary heating process of the embodiment of FIG. 3 provides a burst of energy to the motor and provides quick motor restart.

In the embodiment of FIG. 4, a second blower 66 is provided for the second expansion coil 56. This provides more flexibility to the system, but otherwise, the components operate in the same manner as in the embodiments of FIGS. 1 and 3.

While the preferred forms and embodiments of the invention have been illustrated and described, it will be apparent to those of ordinary skill in the art that various changes and modifications may be made without deviating from the inventive concepts set forth above.

What is claimed is:

1. A power generating system, comprising
(a) a first expansion coil containing a gaseous refrigerant for withdrawing heat from a fluid passing through said fluid expansion coil;
(b) a compressor connected with said first expansion coil and compressing the refrigerant from said first expansion coil to convert the refrigerant to a liquid state at high temperature and pressure;
(c) a heat storage tank connected with said compressor for storing heat from said liquefied refrigerant and converting said liquefied refrigerant to a hot gaseous state;
(d) a motor connected with said heat storage tank and driven by hot gas from said tank to produce mechanical energy from said hot gas while cooling said gas for delivery to said first expansion coil; and
(e) a generator connected with said motor for generating electricity from the mechanical energy produced by said motor.

2. A power generating system as defined in claim 1, wherein said heat storage tank comprises a condenser including an expansion coil which allows the liquefied refrigerant to expand into a hot high pressure gas within said heat storage tank.

3. A power generating system as defined in claim 2, and further comprising a bypass circuit connected with an inlet to said expansion coil and an outlet of said motor for recirculating cooled gas to said heat storage tank and provide for continuous heat absorption by said expansion coil.

4. A power generating system as defined in claim 3, and further comprising expansion valves connected with said expansion coil and with said bypass circuit.

5. A power generating system as defined in claim 3, wherein said motor comprises a gas turbine.

6. A power generating system as defined in claim 3, and further comprising a rectifier connected with said generator for converting variable AC current from said generator into a DC current.

7. A power generating system as defined in claim 6, and further comprising a battery connected with said rectifier for storing DC current.

8. A power generating system as defined in claim 7, and further comprising a voltage converter connected with said battery for producing an electrical output.

9. A power generating system as defined in claim 3, wherein said first expansion coil comprises a plurality of spaced, parallel tubes through which said gaseous refrigerant flows, said tubes absorbing heat from fluid passing through said first expansion coil.

10. A power generating system as defined in claim 2, and further comprising a bypass circuit connected between an output and an input of said heat storage tank.

11. A power generating system as defined in claim 10, and further comprising a controller connected with said compressor, said condenser and said first expansion coil for controlling the operation thereof.

12. A power generating system as defined in claim 11, and further comprising temperature and pressure sensors connected with said system to provide temperature and pressure readings to said controller to control the operation of said compressor, said condenser and said first expansion coil.

13. A power generating system as defined in claim 12, and further comprising a first blower for circulating fluid through said first expansion coil.

14. A power generating system as defined in claim 10, and further comprising a second expansion coil connected with said bypass circuit and a second compressor connected with said second expansion coil for delivering additional hot liquefied refrigerant to said heat storage tank.

15. A power generating system as defined in claim 14, and further comprising a blower for circulating fluid through said first and second expansion coils.

16. A power generating system as defined in claim 14, and further comprising a first blower for circulating fluid through said first expansion coil and a second blower for circulating a fluid through said second expansion coil.

17. A power generating system as defined in claim 9, wherein said absorption tubes include at least one fin.
